(19) United States
(12) Patent Application Publication
(10) Pub. No.: US 2004/0169737 A1
(43) Pub. Date: Sep. 2, 2004

(54) Image sensing apparatus, image sensing method, recording medium, and program

(76) Inventor: Yoshiro Udagawa, Saitama (JP)

Correspondence Address: MORGAN & FINNEGAN, L.L.P., 345 PARK AVENUE, NEW YORK, NY, 10154, US

(21) Appl. No.: 10/772,952

(22) Filed: Feb. 4, 2004

(30) Foreign Application Priority Data
Feb. 6, 2003 (JP) 2003-029970

(51) Int. Cl. H04N 5/217

(52) U.S. Cl. 348/222.1; 347/247

(57) ABSTRACT

A driving circuit drives an image sensing device by a plurality of driving schemes. A memory stores pixel defect information as information about a pixel defect in the image sensing device in correspondence with each driving scheme. A signal processing circuit corrects the pixel defect by referring to the pixel defect information in the memory in accordance with the driving scheme with which the driving circuit drives the image sensing device.

### FIELD OF THE INVENTION

The present invention relates to an image sensing apparatus having an image sensing device and, more particularly, to correction of pixel defects in an image sensing device.

### BACKGROUND OF THE INVENTION

In a conventional image sensing apparatus, the following measure is taken to correct pixel defects in an image sensing device.

For example, when the number of pixels in the image sensing device is small, an image sensing device having no pixel defects is used at the time of manufacturing an image sensing apparatus. This prevents any flaw due to pixel defects from being formed on an image generated by the image sensing apparatus.

However, since the number of pixels in an image sensing device recently tends to increase, it is very difficult to manufacture an image sensing device having no pixel defects at all. Even if it is possible, the cost increases because the yield decreases.

To prevent this, immediately before shipment of the products as image sensing apparatuses having image sensing devices, the position information of each pixel defect in an image sensing device is checked and stored for each product of an image sensing apparatus. A dedicated correction circuit executes processing to make flaws, which are formed on an image generated by the image sensing apparatus due to the pixel defects, unnoticeable.

However, in, e.g., a digital still camera (image sensing apparatus), only still images recorded on a recording medium or the like can undergo the above-described pixel defect correction. The pixel defect correction is not executed for an image displayed on an EVF (Electric View Finder) monitor that is often used in a digital still camera.

This is because the image sensing device driving mode in generating an image to be displayed on an EVF monitor is different from that in generating a still image, and the normal pixel defect correction processing cannot be applied. For this reason, a considerably noticeable flaw may be formed on an image displayed on the EVF monitor depending on the degree of pixel defect, resulting in a poor image quality.

### SUMMARY OF THE INVENTION

The present invention has been made in consideration of the above problem, and has as its object to provide an image sensing apparatus capable of correcting pixel defects in an image sensing device in accordance with the image sensing device driving mode.

The present invention has been made to solve the above-described problem. According to the present invention, there is provided an image sensing apparatus having an image sensing device, comprising driving means for driving the image sensing device by a plurality of driving schemes, pixel defect information storage means for storing pixel defect information as information about a pixel defect in the image sensing device in correspondence with each driving scheme, and correction means for correcting the pixel defect by referring to the pixel defect information in the pixel defect information storage means in accordance with the driving scheme with which the driving means drives the image sensing device.

Accordingly, in the image sensing apparatus of the present invention, the pixel defect in the image sensing device can be corrected by referring to the pixel defect information in accordance with the driving mode (driving scheme) of the image sensing device in the image sensing apparatus.

According to the present invention, the foregoing object is attained by providing an image sensing apparatus having an image sensing device, comprising: driving means for driving the image sensing device by a plurality of driving schemes; pixel defect information storage means for storing pixel defect information as information about a pixel defect in the image sensing device in correspondence with each driving scheme; and correction means for correcting the pixel defect by referring to the pixel defect information in the pixel defect information storage means in accordance with the driving scheme with which the driving means drives the image sensing device.

In a preferred embodiment, the pixel defect information is formed from basic pixel defect information generated by driving the image sensing device by a basic driving scheme and detecting the pixel defect and the other pixel defect information corresponding to the other driving scheme, which is generated on the basis of a relationship between the other driving scheme and the basic driving scheme and the basic pixel defect information.

In a preferred embodiment, the basic driving scheme is a driving scheme that reads all pixels of the image sensing device.

In a preferred embodiment, a data amount of the other pixel defect information is smaller than that of the basic pixel defect information.

In a preferred embodiment, the pixel defect information storage means is a nonvolatile recording medium.

According to the present invention, the foregoing object is attained by providing an image sensing method using an image sensing apparatus having an image sensing device and driving means for driving the image sensing device by a plurality of driving schemes, comprising: correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.

According to the present invention, the foregoing object is attained by providing a computer-readable recording medium which records a program for an image sensing apparatus having an image sensing device and driving means for driving the image sensing device by a plurality of driving schemes, characterized by causing a computer in the image sensing apparatus to execute processing for correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.

According to the present invention, the foregoing object is attained by providing a program for an image sensing apparatus having an image sensing device and driving means for driving the image sensing device by a plurality of driving schemes, characterized by causing a computer in the image sensing apparatus to execute processing for correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic arrangement of a digital still camera according to an embodiment of the present invention;

FIG. 2 is a view showing examples of pixel defects in a CCD image sensing device 101 shown in FIG. 1 and pixels to be selectively used for each driving mode;

FIGS. 3A and 3B are views showing examples of pixel defect information stored in an FROM 112 in a still image mode and EVF mode; and

FIG. 4 is a view showing comparison of times necessary for setting pixel defect information at the time of activation in different pixel defect information generation/referring methods corresponding to the driving modes.

### DETAILED DESCRIPTION OF THE PREFERRED EMBODIMENT

A preferred embodiment of the present invention will be described in detail in accordance with the accompanying drawings.

The schematic arrangement of a digital still camera (image sensing apparatus) according to an embodiment of the present invention will be described first.

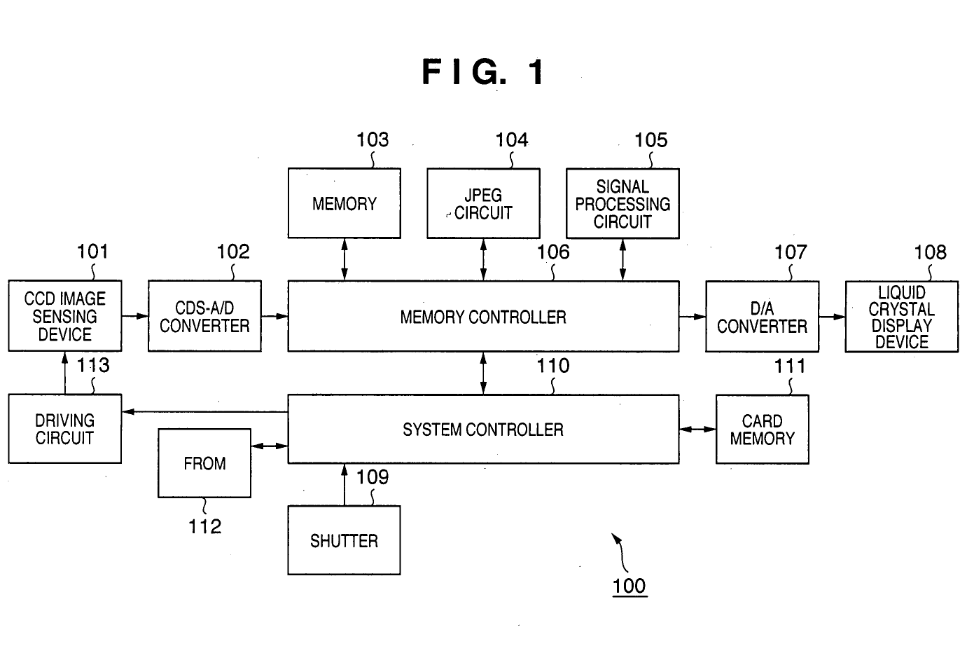

FIG. 1 is a block diagram showing the schematic arrangement of the digital still camera according to an embodiment of the present invention. Referring to FIG. 1, a digital still camera 100 has the following constituent elements. A CCD (Charge Coupled Device) image sensing device 101 outputs an electrical signal corresponding to the luminance of an object whose image is formed on the image sensing plane.

The CCD image sensing device 101 is an area sensor which senses a color image. In the CCD image sensing device 101, pixels having a plurality of types of color filters are two-dimensionally arrayed. Some of these pixels are pixel defects. The pixel array and examples of pixel defects will be described later.

Although not illustrated in FIG. 1, the digital still camera 100 has an optical system constituted by a lens and aperture mechanism to form an object image on the image sensing plane of the CCD image sensing device 101.

The CCD image sensing device 101 has a plurality of driving modes.

More specifically, the CCD image sensing device 101 has two driving modes: a still image mode in which the pixel data of all pixels are read in obtaining still image data and an EVF mode in which pixel data in the vertical direction are thinned out and read in obtaining image data for the EVF. The types of driving modes are not limited to those described above. The CCD image sensing device may have various driving modes.

A CDS (Correlated Double Sampling)—A/D (Analog/Digital) converter 102 executes sampling and A/D conversion of the electrical signal output from the CCD image sensing device 101. A memory 103 temporarily stores image data to be processed in the digital still camera 100. A JPEG (Joint Photographic Experts Group) circuit 104 executes JPEG compression processing for uncompressed image data.

A signal processing circuit 105 executes signal processing to, e.g., generate image data by processing image sensing data.

More specifically, the signal processing circuit 105 has a detection function (detection means) of detecting pixel defects in the CCD image sensing device 101 and a correction function (correction means) of correcting the pixel defects by interpolating pixel data omitted due to the pixel defects in the CCD image sensing device 101 by using the pixel data of neighboring pixels on the basis of information about the positions of the pixel defects.

The detection function and correction function of the signal processing circuit 105 will be described later in detail.

A memory controller 106 controls image data exchange between the memory 103 and other processing circuits.

The CDS-A/D converter 102 is connected to the memory controller 106 so that the image sensing data is input to the memory controller 106. The memory controller 106 is also connected to the memory 103, the JPEG circuit 104, the signal processing circuit 105, a system controller 110, and a D/A (Digital/Analog) converter 107 (to be described later).

The D/A converter 107 converts an image data (digital data) sequence to be displayed on a liquid crystal display device 108 into an analog signal.

The liquid crystal display device 108 also serves as an EVF monitor on which the user confirms the object image during image sensing. That is, the EVF mode is the driving mode of the image sensing device 101 when an object image to be photographed is displayed on the liquid crystal display device 108.

A shutter switch 109 is pressed by the user at timing of obtaining a still image.

The system controller 110 controls the operation of the entire digital still camera 100.

More specifically, the system controller 110 controls a driving circuit (CCD driver) 113 that drives the CCD image sensing device 101 or controls the memory controller 106. With this control, the system controller 110 changes the driving mode of the CCD image sensing device 101.

The system controller 110 is connected to the shutter 109 to detect that it is pressed.

A card memory 111 stores final image data.

The card memory 111 is connected to the system controller 110 through, e.g., a dedicated interface circuit to record image data or erase recorded image data under the control of the system controller 110.

Examples of the card memory are a compact flash, smart media, SD card, and MM (MultiMedia card).

An FROM 112 is a nonvolatile programmable memory which stores firmware data necessary for activating the digital still camera 100. The FROM 112 is connected to the system controller 110. Any other nonvolatile memory such as an EEPROM may be used in place of the FROM.

The driving circuit 113 drives the CCD image sensing device 101 in various driving modes under the control of the system controller 110.

The main operation of the digital camera 100 shown in FIG. 1 will be described next.

The CCD image sensing device 101 outputs a CCD output signal which is an electrical signal generated by photoelectrically converting an object image formed on the image sensing plane. The CDS-A/D converter 102 samples the CCD output signal and converts it into a digital signal to output photographing data.

The memory controller 106 stores photographing data of one frame in the memory 103. The signal processing circuit 105 reads out the photographing data from the memory 103 through the memory controller 106 and processes the photographing data to generate image data.

The JPEG circuit 104 executes JPEG compression processing for the image data generated by the signal processing circuit 105. The system controller 110 records the JPEG-compressed image data on the card memory 111.

With the above operation, the digital camera 100 can record, on the card memory 111, the JPEG image data obtained when the user presses the shutter 109.

When an image display switch (not shown in FIG. 1) is turned on, the signal processing circuit 105 reads out the image sensing data from the memory 103 through the memory controller 106 and generates display data to be displayed on the liquid crystal display device 108. Accordingly, the D/A converter 107 outputs, to the liquid crystal display device 108, a display signal obtained by converting the display data into an analog signal. The liquid crystal display device 108 displays the photographed image.

The FROM 112 also holds information (to be referred to as pixel defect information hereinafter) about pixel defects in the CCD image sensing device 101.

Pixel defect information is, e.g., an address (formed from an X address and a Y address) that specifies the position of a pixel defect.

The system controller 110 is connected to the FROM 112. Immediately after image sensing data is stored in the memory 103, the system controller 110 refers to the pixel defect information in the FROM 112 and transfers the information to the signal processing circuit 105. On the basis of the pixel defect information, the signal processing circuit 105 executes correction processing by rewriting the pixel defect data by interpolating the pixel at the corresponding address by using the pixel data of upper, lower, left, and right pixels having the same color filter.

Various methods can be used to select the neighboring pixel data to be used for defect correction and execute interpolation using the selected pixel data. A plurality of kinds of pixel defect information may be stored in the FROM 112 in correspondence with the respective driving modes of the CCD image sensing device 101.

In this embodiment, there are first pixel defect information (basic pixel defect information) corresponding to the still image mode and second pixel defect information (other pixel defect information generated on the basis of the basic pixel defect information) corresponding to the EVF mode. Detailed examples of the two kinds of pixel defect information will be described later.

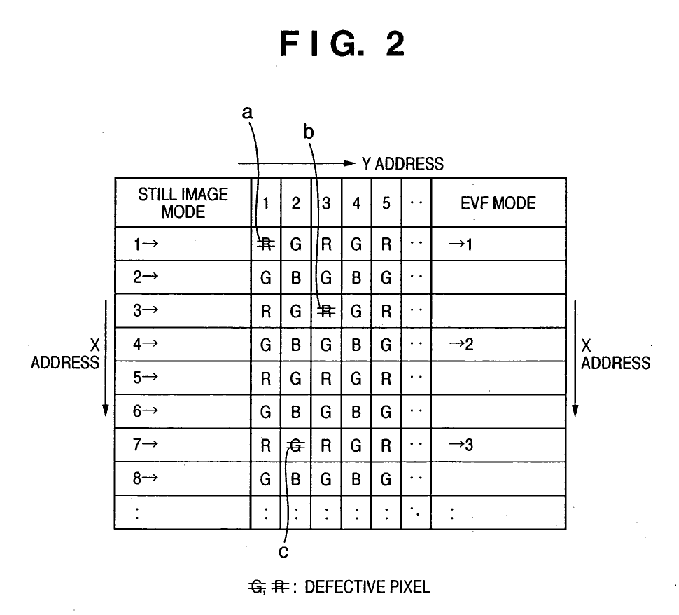

Examples of pixel defects in the CCD image sensing device 101 and pixels to be selectively used for each driving mode will be described next with reference to FIG. 2.

FIG. 2 is a view showing examples of pixel defects in the CCD image sensing device 101 shown in FIG. 1 and pixels to be selectively used for each driving mode.

As shown in FIG. 2, the CCD image sensing device 101 has a pixel array having RGB (red, green, and blue) color filters. Three pixel defects a, b, and c are present. In the still image mode, all pixels are read. In the EVF mode, thinning is executed in the vertical direction in the pixel array of the CCD image sensing device 101, thereby increasing the speed of pixel signal read processing for one frame. In this case, pixel defect information corresponding to the driving mode, which is stored in the FROM 112, is as follows.

When the driving mode of the CCD image sensing device 101 is the still image mode, the pixel data of all the pixels of the CCD image sensing device 101 are read. Hence, the addresses of pixel defects stored in the FROM 112 as the first pixel defect information are as follows.

Pixel defect a: X address=1, Y address=1

Pixel defect b: X address=3, Y address=3

Pixel defect c: X address=7, Y address=2

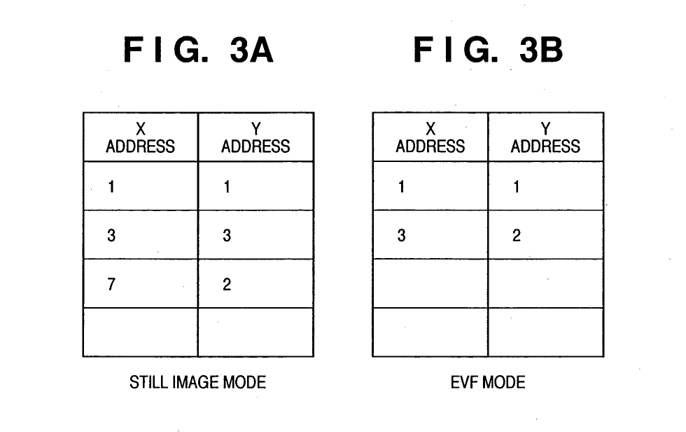

More specifically, as shown in FIG. 3A, only the pieces of information of the X and Y addresses are stored in the FROM 112 as the first pixel defect information in the still image mode.

When the driving mode of the CCD image sensing device 101 is the EVF mode, the pixels of the CCD image sensing device 101 are thinned out in the vertical direction and read. Hence, as shown in FIG. 2, lines in the EVF mode discretely correspond to the lines of the CCD image sensing device 101 in the following way.

First line→first line in the EVF mode

Fourth line→second line in the EVF mode

Seventh line→third line in the EVF mode

The addresses of pixel defects stored in the FROM 112 as the second pixel defect information corresponding to the EVF mode are as follows.

Pixel defect a: X address=1, Y address=1

Pixel defect c: X address=3, Y address=2

More specifically, as shown in FIG. 3B, only the pieces of information of the X and Y addresses are stored in the FROM 112 as the second pixel defect information in the EVF mode.

The second pixel defect information in the EVF mode can be generated in correspondence with pixels to be used in the EVF mode on the basis of the first pixel defect information which is generated by detecting the pixel defects in the driving mode (the still image mode in this embodiment) for reading all the pixels of the CCD image sensing device 101.

In this embodiment, two driving modes are used. However, even when the number of driving modes is three or more, pixel defect information for each driving mode can be generated on the basis of the first pixel defect information. With this arrangement, since pixel defect information need not be detected for each driving mode, the manufacturing process can be simplified.

If there are many driving modes, and pixel defect information for each driving mode is generated every time the digital still camera 100 is powered on and activated, the pixel defect information generation processing takes a long time. In this embodiment, however, once pixel defect information is generated, it is stored in the FROM 112. For this reason, the digital still camera 100 can be activated without consuming time to generate pixel defect information for each driving mode.

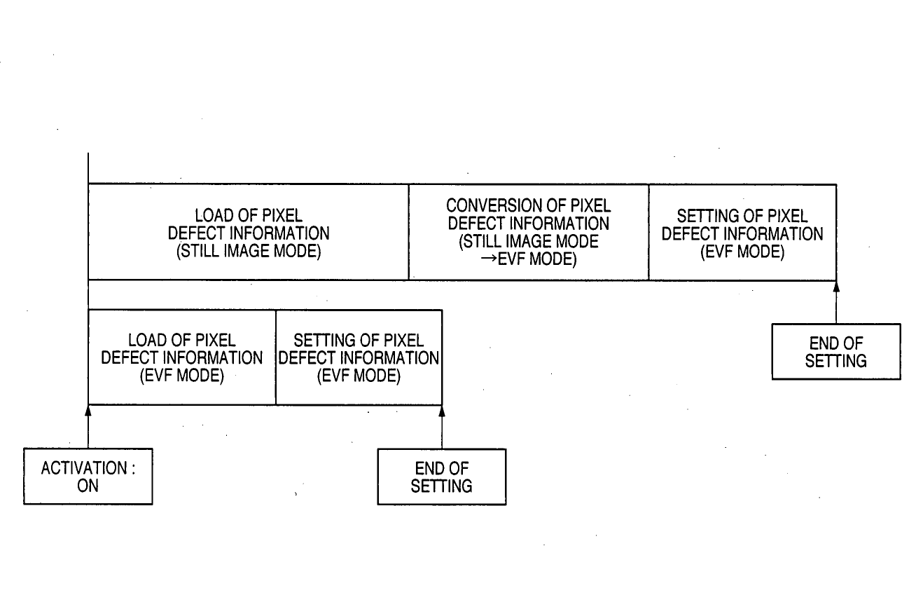

FIG. 4 is a view showing comparison of times necessary for setting pixel defect information at the time of activation between a case wherein pixel defect information is generated for each driving mode every time the digital still camera is activated and a case wherein pixel defect information generated once for each driving mode is stored in the FROM 112 and referred to every time the digital still camera is activated.

As shown in FIG. 4, when pixel defect information is generated for each driving mode every time the digital still camera is activated, three steps, i.e., load of pixel defect information (still image mode), conversion of pixel defect information, and setting of pixel defect information (EVF mode) are necessary from the activation to the end of setting of the pixel defect information.

To the contrary, when pixel defect information generated once for each driving mode is stored in the FROM 112 and referred to every time the digital still camera is activated, only two steps, i.e., load of pixel defect information (EVF mode) and setting of pixel defect information are necessary. The time is obviously shorter.

In addition, the data amount of pixel defect information (second pixel defect information) corresponding to the EVF mode is often smaller than that of pixel defect information (first pixel defect information) corresponding to the still image mode because the pixels are thinned out. In this case, the time to read the pixel defect information can also be shortened. Hence, the difference in total time may be large.

As described above, in the digital still camera 100 according to this embodiment, pixel defect information for each driving mode of the CCD image sensing device 101 can efficiently be generated. In addition, since pixel defect information (first pixel defect information) detected once for one driving mode can be used to generate the other pixel defect information corresponding to the other driving mode, the pixel defect information can efficiently and effectively be stored in the FROM 112.

In the EVF mode, since the EVF monitor used to confirm an image is small, only relatively large pixel defects are noticeable, as compared to image data generated in the still image mode. By using this fact, when the second pixel defect information corresponding to the EVF mode is generated by using only several ten higher order data of the first pixel defect information as pixel defect information, the data amount of the second pixel defect information becomes small. Hence, load at a higher speed can be realized.

For example, when the first pixel defect information is compressed, a time to decompress it is also necessary. However, when the data amount of the second pixel defect information is small, compression is unnecessary.

The image sensing apparatus of the present invention need not always be a digital still camera. It may be an image sensing apparatus such as a video camera having an image sensing device. In the above-described embodiment, the image sensing device prepared in the image sensing apparatus is a CCD image sensing device. However, the present invention is not limited to this. A CMOS sensor may also be used.

The above-described CCD image sensing device has RGB color filters. However, the present invention is not limited to this. A CCD image sensing device having color filters of complementary colors or a monochrome CCD image sensing device having no color filters may be used. In the above-described embodiment, only pixels in the vertical direction are thinned out in the EVF mode. However, the present invention is not limited to this. Only pixels in the horizontal direction may be thinned out, or pixels in both the vertical and horizontal directions may be thinned out.

The system controller 110 of the digital still camera 100 shown in FIG. 1 may be implemented by dedicated hardware. Some or all parts of the system controller 110 may be constituted by a memory and a CPU (Central Processing Unit). Its processing may be realized by loading programs for realizing various processing operations of the system controller 110 in the memory and executing the programs.

The memory is constituted by a nonvolatile memory such as a hard disk device, magnetooptical disk device, or flash memory, a read-only recording medium such as a CD-ROM, a volatile memory such as a RAM (Random Access Memory), or a computer-readable and writable recording memory based on a combination thereof.

The system controller 110 shown in FIG. 1 is also implemented when the internal computer of the digital still camera 100 reads out a program for realizing the functions of the above-described embodiment from a recording medium storing the program and executes it. The functions of the above-described embodiment are also implemented when the operating system (OS) running on the computer performs part or all of actual processing on the basis of the instructions of the program read out by the computer.

The functions of the above-described embodiment may also be implemented when program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

The embodiment of the present invention has been described above in detail with reference to the accompanying drawings. The detailed arrangement is not limited to the embodiment, and any design within the spirit and scope of the invention is also incorporated.

As described above, the image sensing apparatus according to the present invention comprises a driving means for driving the image sensing device by a plurality of driving schemes, a pixel defect information storage means for storing pixel defect information as information about a pixel defect in the image sensing device in correspondence with each driving scheme, and a correction means for correcting the pixel defect by referring to the pixel defect information in the pixel defect information storage means in accordance with the driving scheme with which the driving means drives the image sensing device. Hence, the pixel defect in the image sensing device can be corrected by referring to the pixel defect information in accordance with the driving mode (driving scheme) of the image sensing device in the image sensing apparatus. In addition, since the pixel defect information corresponding to each driving mode of the image sensing device is stored in the pixel defect information storage means, pixel defect correction corresponding to each driving mode can quickly be executed as compared to a case wherein pixel defect information corresponding to each driving mode is generated on the basis of basic pixel defect information.

The present invention is not limited to the above embodiments and various changes and modifications can be made within the spirit and scope of the present invention. Therefore, to apprise the public of the scope of the present invention, the following claims are made.

What is claimed is:

1. An image sensing apparatus having an image sensing device, comprising:
driving means for driving the image sensing device by a plurality of driving schemes;
pixel defect information storage means for storing pixel defect information as information about a pixel defect in the image sensing device in correspondence with each driving scheme; and
correction means for correcting the pixel defect by referring to the pixel defect information in said pixel defect information storage means in accordance with the driving scheme with which said driving means drives the image sensing device.

2. The apparatus according to claim 1, wherein the pixel defect information is formed from basic pixel defect information generated by driving the image sensing device by a basic driving scheme and detecting the pixel defect and the other pixel defect information corresponding to the other driving scheme, which is generated on the basis of a relationship between said other driving scheme and the basic driving scheme and the basic pixel defect information.

3. The apparatus according to claim 2, wherein the basic driving scheme is a driving scheme that reads all pixels of the image sensing device.

4. The apparatus according to claim 2, wherein a data amount of said other pixel defect information is smaller than that of the basic pixel defect information.

5. The apparatus according to claim 1, wherein said pixel defect information storage means is a nonvolatile recording medium.

6. An image sensing method using an image sensing apparatus having an image sensing device and driving means for driving the image sensing device by a plurality of driving schemes, comprising:
correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.

7. A computer-readable recording medium which records a program for an image sensing apparatus having an image sensing device and driving means for driving the image sensing device by a plurality of driving schemes, characterized by causing a computer in the image sensing apparatus to execute processing for
correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.

8. A program for an image sensing apparatus having an image sensing device and driving means for driving the image sensing device by a plurality of driving schemes, characterized by causing a computer in the image sensing apparatus to execute processing for
correcting a pixel defect by referring to pixel defect information in pixel defect information storage means in accordance with the driving scheme with which the driving means drives the image sensing device, the pixel defect information storage means storing the pixel defect information as information about the pixel defect in the image sensing device in correspondence with each driving scheme.
